(19) United States
(12) Patent Application Publication
(10) Pub. No.: US 2026/0352547 A1
(43) Pub. Date: Nov. 5, 2026

(54) SELECTING CONFIGURATION CHANGES TO BE PERFORMED IN AN ENVIRONMENT

(71) Applicant: Telefonaktiebolaget LM Ericsson (publ), Stockholm (SE)

(72) Inventors: Ioanna MITSIONI, Stockholm (SE); Jaeseong JEONG, Solna (SE); Maxime BOUTON, Stockholm (SE)

(73) Assignee: Telefonaktiebolaget LM Ericsson (publ), Stockholm (SE)

(21) Appl. No.: 19/487,497

(22) PCT Filed: Oct. 4, 2023
(86) PCT No.: PCT/SE2023/050991

§ 371 Date: Nov. 25, 2025

(30) Foreign Application Priority Data
May 30, 2023 (GR) 20230100429

(51) Int. Cl. H04L 41/0816; H04L 41/16

(52) U.S. Cl. CPC H04L 41/0816; H04L 41/16

(57) ABSTRACT

Method and device for selecting configuration changes to be performed in an environment A computing device (201) obtains (101), from two or more safety shields (203a-d), a recommendation to perform or to not perform a configuration change of the environment. The computing device (201) determines (103) whether to perform the configuration change based on the recommendations and respective priorities associated with the two or more safety shields. The computing device (201) initiates (105) the configuration change if the configuration change is determined to be performed.

### TECHNICAL FIELD

The invention relates to a method for selecting configuration changes to be performed in an environment, a computing device for selecting configuration changes to be performed in an environment, a corresponding computer program, a corresponding computer-readable data carrier, and a corresponding data carrier signal.

### BACKGROUND

Large scale communication networks require automatic adjustment of network parameters configuration to ensure a high level of Quality of Service (QOS) to each User Equipment (UE). Manual tuning of network parameters or hand-engineering strategies to tune the network parameters is costly and not scalable.

Reinforcement learning (RL) is one of the machine learning paradigms used for managing the automated reconfiguration of network parameters, such as network antenna down-tilt angle, downlink power, uplink power, azimuth, cell offset, etc. In RL, an RL agent observes a state of an environment (e.g., a technical system with configurable parameters, such as a communications network), applies an action, such as a configuration change of the network parameters, receives a reward, and transitions to the next state. The RL agent aims to learn an optimal policy that maximizes the cumulative reward over a period of time in a trial-and-error fashion. The environment in which the agent is deployed is initially unknown and thus the RL agent needs to explore, i.e., actively seek out, novel states of the environment and novel actions that might yield high rewards and lead to long-term gains. While exploring unknown state-action pairs, the RL agent is agnostic to safety and therefore it may execute unsafe actions or there can be a mismatch between the simulated version of the environment and the real one, which may lead to unsafe behaviors.

Safe RL (SRL) algorithms aim to increase safety during the interaction with the environment, and at best, guarantee safety with some probability. It is difficult to know a priori what risks may arise during the deployment of the RL agent in the environment and over-constraining the actions that the RL agent may take to be conservative may result in a significant decrease in performance.

Further details on SRL may be found in M. Alshiekh, et al., “Safe reinforcement learning via shielding”, Proceedings of the AAAI Conference on Artificial Intelligence, Vol. 32, No. 1, 2018 pages 4 to 17.

### SUMMARY

It is an object of the invention to provide an improved alternative to the above techniques and prior art. More specifically, it is an object of the invention to provide improved selection of configuration changes to be performed in an environment. This and other objects of the invention are achieved by means of different aspects of the invention, as defined by the independent claims. Embodiments of the invention are characterized by the dependent claims.

According to a first aspect of the invention, a method for selecting configuration changes to be performed in an environment is provided. The method is performed by a computing device. The method comprises obtaining, from each of two or more safety shields, a recommendation to perform or to not perform a configuration change of the environment. The method further comprises determining whether to perform the configuration change based on the recommendations and a priority associated with each of the two or more safety shields. The method further comprises initiating the configuration change if the configuration change is determined to be performed.

According to a second aspect of the invention, a computing device for selecting configuration changes to be performed in an environment is provided. The computing device comprises a processor and a memory. The memory has stored thereon instructions executable by the processor. The instructions, when executed by the processor, cause the computing device to obtain, from each of two or more safety shields, a recommendation to perform or to not perform a configuration change of the environment. The instructions further cause the computing device to determine whether to perform the configuration change based on the recommendations and a priority associated with each of the two or more safety shields. The instructions cause the computing device to initiate the configuration change if the configuration change is determined to be performed.

According to a third aspect of the invention, a computer program is provided. The computer program comprises instructions which, when run in a processing unit on a computing device, cause the computing device to obtain, from each of two or more safety shields, a recommendation to perform or to not perform a configuration change of the environment. The instructions further cause the computing device to determine whether to perform the configuration change based on the recommendations and a priority associated with each of the two or more safety shields. The instructions further cause the computing device to initiate the configuration change if the configuration change is determined to be performed.

According to a fourth aspect of the invention, there is provided a computer-readable data carrier having stored thereon the computer program.

According to a fifth aspect of the invention, there is provided a data carrier signal carrying the computer program.

Certain embodiments may provide one or more of the following technical advantages:
the use of multiple safety shields allows to tackle multiple risk sources simultaneously and to adapt to the given environment and corresponding risks by taking into account both safety and performance;
the solution may be implemented both during a RL training phase and deployment phase;
the solution is modular and therefore supports the inclusion of further safety shields;
the solution may support multiple RL agents (e.g., a communications network with multiple cells or base stations) by the implementation of multiple priorities per safety shield.

### BRIEF DESCRIPTION OF THE DRAWINGS

For better understanding of the present disclosure, and to show more readily how the invention may be carried into effect, reference will now be made, by way of example, to the following drawings, in which:

FIG. 1 shows a flow chart illustrating a method performed by a computing device for selecting configuration changes to be performed in an environment, according to embodiments of the invention;

FIG. 2 shows a schematic illustration of elements of a system comprising a computing device for selecting configuration changes to be performed in an environment, and their interaction, according to embodiments of the invention; and

FIG. 3 is a block diagram depicting a computing device for selecting configuration changes to be performed in an environment, according to embodiments of the invention.

### DETAILED DESCRIPTION

Embodiments will be illustrated herein with reference to the accompanying drawings. These embodiments are provided by way of example so that this disclosure will be thorough and complete, and will fully convey the scope of the inventive concept to those skilled in the art.

To optimize mobile communications network performances, mobile network operators (MNOs) may rely on automated reconfiguration of network parameters, such as base station's parameters (e.g., network coverage parameter, network capacity parameter, network frequency band, network antenna down-tilt angle, network antenna vertical beamwidth, and antenna horizontal beamwidth).

Safe Reinforcement Learning (SRL) is a subcategory of RL methods used for managing the automated reconfiguration of network parameters by introducing safety constraints on actions that an RL agent may perform on the environment, wherein the actions are changes of the network parameters.

Shielding is an SRL implementation wherein a safety shield provides to the RL agent a list of safe actions from which it can choose, or monitors the actions selected by the RL agent and blocks them only if the actions selected by the RL agent cause a violation of the safety constraints. Safety shields are designed for specific use cases and are static, i.e., once a safety shield is deployed, it remains active until an operator decides to manually deactivate it if it is no more beneficial and/or necessary. This may result in a decrease in performance if use cases change during operation.

The invention disclosed herein makes it possible to improve the selection of configuration changes to be performed in an environment by RL agents. According to embodiments of the invention, a computing device obtains, from each of two or more safety shields, a recommendation to perform or to not perform a configuration change of the environment. The computing device determines whether to perform the configuration change based on the received recommendations and a priority associated with each of the two or more safety shields.

The computing device initiates the configuration change if the configuration change is determined to be performed.

The environment may be a technical system (that may be computerized) with configurable parameters, or a simulation of such a technical system (e.g., a digital twin). For example, the environment may be a real deployment or a simulation of a communications network. The environment may have a current configuration, i.e., a set of network parameters with specific values. A state of the environment comprises the current configuration of the environment. The state may further comprise Key Performance Indicator (KPI) values. Performing a configuration change makes the environment transitioning from a first state to a second state. The configuration change may be triggered based on an action. The configuration change may be performed by an RL agent. The configuration change may be the modification of one or more network parameters of one or more radio access nodes of the mobile communications network. Examples of network parameters are network coverage parameter, network capacity parameter, network congestion parameter, network resource allocation, network resource configuration, network usage parameter, network signal quality parameter, network signal interference parameter, network power parameter, network frequency band, network antenna down-tilt angle, network antenna vertical beamwidth, antenna horizontal beamwidth, and horizontal sector shape.

A safety shield is a mediator between the RL agent and the environment. Examples of safety shields are Bayesian shields and k-shields. Differently from known uses of RL agent, wherein an RL agent directly interacts with the environment (e.g., a communications network) by performing an action (e.g., a configuration change) and receiving a feedback (or reward) from the environment, a safety shield acts as a proxy between the RL agent and the environment. The function of the safety shield is to protect the environment from “unsafe” actions that may be selected by the RL agent. The safety shield provides the RL agent with a list of “safe” actions from which it can choose from, or monitors the actions selected by the RL agent and blocks them only if the selected actions are determined to be “unsafe”. An action is determined to be “safe” or “unsafe” to be performed on the environment based on one or more safety constraints generated by the safety logic of the safety shield. An action may be considered “safe” if no undesirable states of the environment are visited. A safety shield (SS) may be defined as a Boolean function SS: S′→{0,1}, wherein S′ is a set of states of the environment and 0 indicates that the state may not be visited and 1 indicates that the state may be visited, or vice versa. Therefore, the safety shield prevents the RL agent from visiting a state that does not satisfy the one or more safety constraints. Examples of safety constraints are
a threshold condition of a network parameter, e.g., maximum value, minimum value, or a range of a Signal to Interference plus Noise Ratio (SINR) value, network coverage, network capacity, network congestion, network resource allocation, network resource configuration, network usage, network signal quality, network power, network frequency band, network antenna down-tilt angle, network antenna vertical beamwidth, antenna horizontal beamwidth, and horizontal sector shape;
a pre-defined safe but suboptimal baseline policy;
a threshold condition of a statistical measurement, e.g., of uncertainty associated with a RL reward obtained after performing a configuration change.

Further details on the safety shields may be found in S. Dey, et al., “Adaptive Safety Shields for Reinforcement Learning-Based Cell Shaping”, IEEE Transactions on Network and Service Management, vol. 19, no. 4, pp. 5034-5043, 2022.

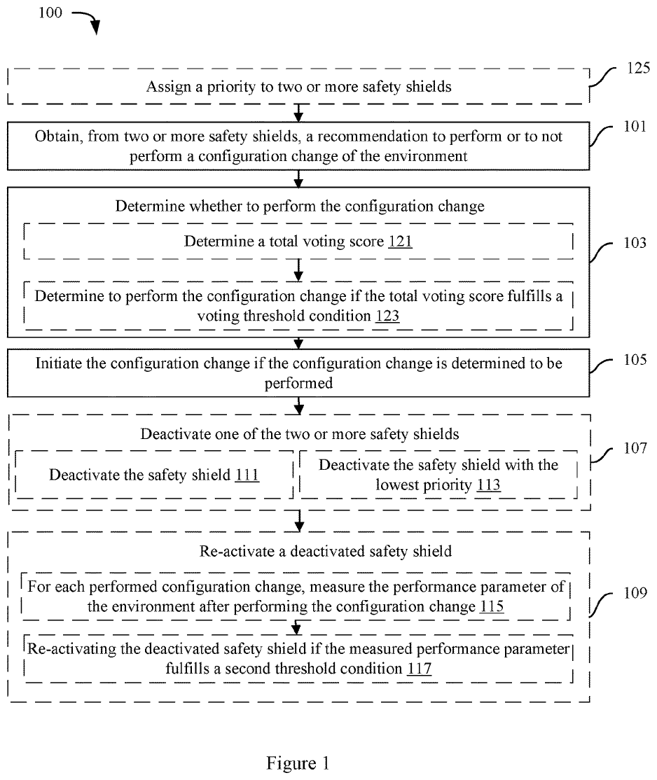

FIG. 1 shows a method 100 for selecting configuration changes to be performed in an environment. The method 100 may be performed by a computing device 201. The computing device 201 may be a router, gateway, Internet of Things (IoT) gateway, or any device with computing, storage, and network connectivity.

The method comprises obtaining 101, from each of two or more safety shields 203a-d, a recommendation to perform or to not perform a configuration change of the environment. The configuration change may be the configuration change selected by a RL agent. One or more of the two or more safety shields 203a-b may further transmit one or more further recommendations to perform or nor perform one or more further configuration changes of the environment. According to an embodiment, each of the two or more safety shields 203a-b may transmit the recommendation for each configuration change. In other words, if there are two safety shields, SS1 and SS2, two possible configuration changes C1 and C2 (e.g., uptilt and downtilt of an antenna), and the RL agent selects C1, the computing device 201 may receive: a recommendation to perform or not perform C1 from SS1, as well as a recommendation to perform or not perform C1 and a recommendation to perform or not perform C2 from SS2.

The environment may be a mobile communications network, such as a third generation (3G), fourth generation (4G), a fifth generation (5G), a sixth generation (6G), telecommunications network, or higher generation. The configuration change comprises a modification of one or more network parameters of one or more radio access nodes of the mobile communications network.

Examples of safety shields are Bayesian shields and k-shields. The recommendation obtained from each of the two or more safety shields 203a-d may be a binary number or a Boolean value. For example, the value 1 (or “true”) may indicate that the configuration change should be performed and the value 0 (or “false”) may indicate that the configuration change should not be performed, or vice versa.

The method further comprises determining 103 whether to perform the configuration change based on the obtained recommendations and respective priorities associated with the two or more safety shields 203a-d. If the configuration change is determined to be performed, the method further comprises initiating 105 the configuration change. In other words, the RL agent is instructed to perform the configuration change if the configuration change is considered “safe”, and the configuration change is applied to the environment.

The method may further comprise assigning 125 a priority to each of the two or more safety shields 203a-d. The computing device 201 may assign the priority to each of the two or more safety shields 203a-d based on user input. The priority may be a numerical value. The priority may be assigned to each of the two or more safety shields statically or dynamically. For example, to avoid having one of the two or more safety shields dominating the configuration change recommendation, the priorities may be set to ensure that the highest priority is always smaller or equal to the sum of the remaining priorities. Alternatively, one of the two or more safety shields selected by the user may have the highest priority and the remaining safety shields may be used to determine fallback configuration changes. The computing device 201 may dynamically change the priorities based on measured performance parameters of the environment, wherein the performance parameters are measured after performing a configuration change. For example, the computing device 201 may monitor a performance parameter within a period of time, e.g., a day, and decrease the priority of a safety shield if the configuration changes performed during the period of time were recommended by that safety shield and the value of the performance parameter after performing the configuration changes shows a degradation of performance in the period of time. Performance parameters may comprise coverage, capacity, and quality KPI values. Coverage indicates to which extent an area of interest is covered by the communications network, and may be evaluated by using measurements of Reference Signal Received Power (RSRP), Radio Resource Control (RRC) failure rate, signal strength of user equipment (UEs) located at cell edge, or the like. Capacity indicates the number of UEs that a cell can manage simultaneously (e.g., in terms of number of calls), and may be evaluated by using measurements of average SINR. Quality indicates the effect of cell interference from neighboring cells (e.g., in terms of cell traffic congestion), and may be evaluated by measuring cell overshooting and cell overlapping indicators, which in turn depend on measurements of the RSRP level differences between a cell and its neighbors.

In case of multi-agent (i.e., two or more RL agents) scenario, e.g., a communications network with multiple cells or multiple base stations, the method may further comprise assigning 125 multiple priorities to each of the two or more safety shields. A priority of a safety shield is associated with a corresponding RL agent (e.g., one cell of the multiple cells), of the two or more agents.

According to an embodiment, determining 103 whether to perform the configuration change may be further based on a respecting voting score assigned by the two or more safety shields to the configuration change. The voting scores assigned to the configuration change by each safety shield may than be added up or averaged by the computing device 201 to determine 121 a total voting score for the configuration change.

The two or more safety shields 203a-b may further assign a voting score to the one or more further configuration changes of the environment. The voting scores assigned to each of the one or more further configuration changes by each one or more of the two or more safety shields may than be added up or averaged by the computing device 201 to determine 121 a total voting score for each of the one or more further configuration changes. This voting system creates a ranking of the available configuration changes with respect to their safety.

If the total voting score assigned to a configuration change fulfills a voting threshold condition, then the configuration change is determined 123 to be performed. If two or more configuration changes have a same total voting score and the total voting score fulfills the threshold condition, then the configuration change determined to be performed is the one of the two or more configuration changes that was recommended by the safety shield with the highest priority. If neither of the total voting scores assigned to the one or more configuration changes fulfills the voting threshold condition, then a fallback policy may be applied. The fallback policy may be a pre-defined safe but suboptimal baseline policy or a user-defined configuration change.

The voting score assigned to a configuration change by a safety shield may be determined based on a confidence score, on the priority assigned to the safety shield, and/or on the recommendation determined by the safety shield. The confidence score is a value indicating the uncertainty associated with the recommendation. The confidence score may, e.g., be expressed through entropy. The voting score

$${vote}_{{SS}_{i}}^{{a}_{t}}$$

for the configuration change aₜ assigned by the safety shield SSᵢ may, e.g., be calculated using the formula

$${vote}_{{SS}_{i}}^{{a}_{t}} = {priority}_{{SS}_{i}}^{{a}_{t}} \times {confidence}_{{SS}_{i}}^{{a}_{t}} \times {output}_{{SS}_{i}}^{{a}_{t}} , \qquad ( Equation 1 )$$

wherein

$${priority}_{{SS}_{i}}^{{a}_{t}}$$

is the priority value assigned to the safety shield i,

$${confidence}_{{SS}_{i}}^{{a}_{t}}$$

is the confidence score indicating the uncertainty associated with the recommendation of the configuration change aₜ, and

$${output}_{{SS}_{i}}^{{a}_{t}}$$

is a binary value indicating if the safety shield SSᵢ considers the configuration change aₜ, unsafe

$$( e . g . , {output}_{{SS}_{i}}^{{a}_{t}} = 1 )$$

or not

$$( e . g . , {output}_{{SS}_{i}}^{{a}_{t}} = 0 ) ,$$

or vice versa.

For example, if the total voting score assigned to each of three configuration changes is [0.6, 2, 5], and the voting threshold condition is that a total voting score lower than a value equal to 2 indicates a safe configuration change, the first configuration change is the one determined 103 to be performed and therefore initiated 105.

The total voting score may be saved in a buffer. The buffer may be created by the computing device 201. The length of the buffer depends on the number of configuration changes. The buffer may be initialized to zero and updated when the computing device 201 receives a voting score from a safety shield.

According to an embodiment, the method further comprises deactivating one of the two or more safety shields 203a-d. A deactivated safety shield does not contribute to the selection of the (final “safe”) configuration change initiated 105 by the computing device 201. For example, one of the two or more safety shields 203a-d may be deactivated 107 based on a value of an RL reward function evaluated after performing the configuration change recommended by that safety shield, and/or based on the priority associated with each of the two or more safety shields 203a-d. For example, a safety shield SS1 may be deactivated 111 if the value of the RL reward function evaluated after performing the configuration change recommended by the safety shield SS1 is lower than a further value of the RL reward function evaluated after performing a further configuration change recommended by a further safety shield SS2. In other words, the computing device 201 may detect if there is a decrease in the cumulative RL reward (i.e., the sum of the RL rewards obtained after performing each configuration change) and deactivate one or more safety shields 203a-d. A decrease in the cumulative RL reward may be due to overly restricting the RL agent and not letting it explore the environment to sufficient extent because the number of active safety shields is too high.

The computing device 201 may, for example, determine the one or more safety shields to deactivate by monitoring how many times, N, performing the configuration changes recommended by each safety shield 203a-d generates an RL reward lower than the RL reward evaluated by performing a previous configuration change. When the computing device 201 detects a decrease in the cumulative RL reward, the one or more safety shields with N fulfilling a first threshold condition (such as highest N, or N being higher than a threshold value) are deactivated. Information on the first threshold condition and/or priority may be comprised in a safety specification given as input to the computing device 201 by a user. For example, the RL agent's training may be done for a number of epochs (or timesteps), and the safety specification may define as the first threshold condition that a safety shield, SS₁, should be deactivated if the cumulative reward, R, obtained after performing the configuration change recommended by the safety shield SS₁ is lower than 80 with a tolerance (measured in terms of timesteps t wherein the cumulative reward is lower than 80) of 3. If the cumulative RL reward at each timestep obtained after performing a configuration change recommended by the safety shield SS₁ has for example the following values:

R(t)=100,R(t+1)=80,R(t+2)=75,R(t+3)=70,R(t+4)=68

then the computing device 201 would detect that that cumulative reward R is decreasing and, since the cumulative reward R has been lower than 80 three times, it would deactivate the safety shield SS₁.

As another example, the computing device 201 may deactivate 113 the safety shield with the lowest priority if the value of the (cumulative) RL reward function evaluated after performing the configuration change fulfills the first threshold condition, wherein the configuration change may be the configuration change recommended by the safety shield with the lowest priority or by a further safety shield. The choice of deactivating the safety shield with the lowest priority may allow to relax the safety constraints and take into account the user's specification. If the user has assigned a static priority to the safety shields, the safety shield with the lowest priority is most likely the one considered less important by the user.

According to an embodiment, the method may further comprise re-activating 109 a deactivated safety shield 203a-d. The re-activation of a deactivated safety shield 203a-d may be based on the one or more performance parameters of the environment.

For each performed configuration change, the method may further comprise measuring 115 the performance parameter of the environment after performing the configuration change. The method may further comprise re-activating 117 the deactivated safety shield if the measured performance parameter fulfills a second threshold condition. The safety specification may further comprise the second threshold condition. The method 100 may further comprise extracting the safety specification by parsing the user input.

It will be appreciated that the method 100 may comprise additional, alternative, or modified, steps in accordance with what is described throughout this disclosure.

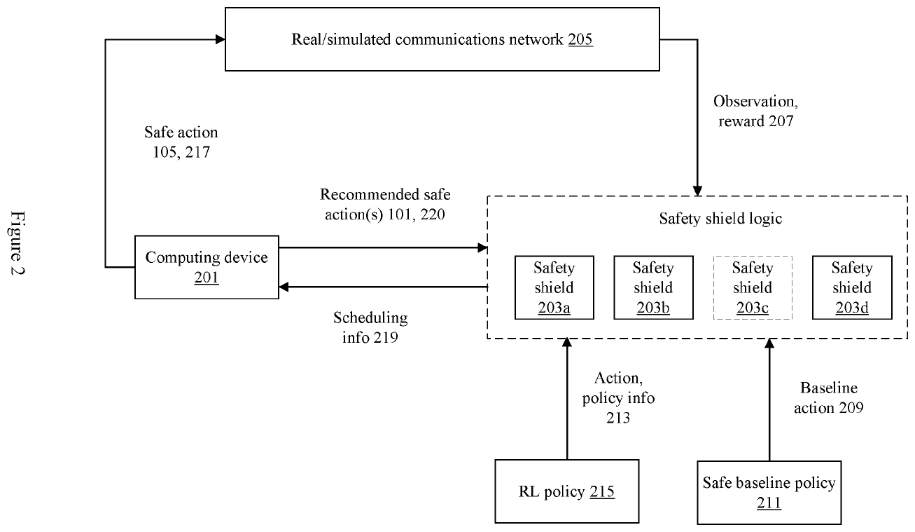

FIG. 2 schematically shows a high-level view of elements of a system comprising
an environment (e.g., the communications network) 205, i.e., the real environment or the simulated environment that an RL agent is acting upon;
a computing device 201, or adaptive safety shield manager, performing a method 100 according to embodiments;
a set of safety shields 203a-d grouped under safety shield logic in FIG. 2.

The safety shields 203a-d may receive information 207 from the environment 205, wherein the information may comprise observations on a current state of the environment, e.g., a current configuration of network parameters, and a reward obtained after performing an action, i.e., a change of the configuration of the network parameters. The safety shields 203a-d may also receive as input a baseline action 209 determined by a baseline policy 211, i.e., a predefined suboptimal configuration change that fulfills the safety constraints of the safety specification. The baseline policy may be generated based on expert knowledge and the safety constraints. The safety shields 203a-d may also receive as input information 213 on an RL policy 215, i.e., recommended configuration changes that optimize the cumulative reward, and information on the algorithm used by the safety shields (e.g., a probability density function (PDF) of Q-values and/or statistics of performance indicators, such as average reward over a number of epochs).

Each safety shield 203a-d transmits 201, 220 a recommendation (recommended safe actions) to the computing device 201 to perform or to not perform a configuration change of the environment. The recommendation may be based on the current state of the environment, the reward, the baseline action 209, the information from the RL policy 215, and/or an internal policy of the safety shields. The safety shields 203a-d may also transmit a confidence score indicating the uncertainty associated with the recommendation.

The computing device 201 receives the recommendations, determines 103 whether to perform the configuration change based on the recommendations and respective priorities associated with the two or more safety shields, and initiates 105, 217 the configuration change (safe action) if the configuration change is determined to be performed. The computing device 201 may also determine 103 whether to perform the configuration change based on a safe baseline policy.

The computing device 201 may determine scheduling information 219, i.e., the safety shields to deactivate 207, 211, 213 and/or re-activate 109, 217. With reference to FIG. 2, as an example, the dashed safety shield 203c is inactive.

An example scenario in which a solution according to embodiments of the invention may be implemented is remote electrical tilt (RET) optimization. An antenna tilt of a base station is defined as the angle between the main beam of the antenna and the horizontal plane. The antenna tilt is measured in degrees and can have positive and negative values. A negative value is referred as uptilt and indicates that the main beam is directed upwards. A positive value is referred as downtilt and indicates that the main beam is directed downwards. The RET optimization allows the antenna tilt to be adjusted remotely, using electromechanical actuators for phase shifting, to optimize KPIs of the communications network. Uptilt results in larger covered area in the cell and smaller capacity due to lower signal power received; downtilt results in a smaller covered area with increased capacity, with the risk of creating coverage holes in the cell. Moreover, the cell's performance is influenced by the tilt of the neighboring cells that introduces coupled interference between cells, modeled by the quality KPI. Therefore, the RET optimization problem aims to maximize the capacity, the coverage, and the quality.

Considering as an example a single cell that is optimizing its antenna tilt based on its own and neighboring cells' measurements of coverage, capacity, and quality, the RL agent is associated with the cell and the configuration changes (or actions) are aₜ ∈[Δ_{θ}, θ, −Δ_{θ}], wherein Le denotes the maximum magnitude of the downtilt, 0 indicates that no adjustment of the tilt shall be performed, and −Δ_{θ} denotes the maximum magnitude of the uptilt. A voting threshold condition may be to consider a configuration change to be “safe” if the total voting score is 0.

Two safety shields that may be used are:
K-shield with priority 1, wherein the k-shield recommends one of an action recommended by one or more baseline policies or an action selected by a RL agent, based on a probability distribution of a random variable controlled by a parameter k. The parameter k denotes the priority between the one or more baseline policies and the RL agent. In the beginning of the training phase, the RL agent will probably select more exploration actions which can in turn be unsafe, therefore the actions recommended by the one or more baseline policies are prioritized through k. The more the RL agent learns about the environment, the more the actions selected by the RL agent will be safe and therefore the actions selected by the RL agent are prioritized through k. Further details on the k-shield may be found in WO 2022/023218 A1;
Bayesian shield with priority 2, wherein the Bayesian shield estimates the safe action for the RL agent to perform by taking into account the presence of noise/uncertainty (due to for example to neighboring cells interference, or mobility of the UE) in the measurement of KPI values (comprised in the observation of the environment). The Bayesian shield receives as input the current state of the environment (which is not the actual (“true”) state due to noisy or faulty information), determines with a confidence score in which “hidden” state the environment is, i.e., the state not affected by noise or faulty information, and recommends the best action for the RL agent to perform. The “hidden” states are defined based on domain knowledge. Further details on the Bayesian shield may be found in WO 2022/253625 A1.

At timestep t, during the exploration phase, the RL agent may select the action at =−40, i.e., tilt the antenna up.

The computing device 201 may save in a temporary buffer the total voting score determined based on embodiments of the invention. Since we are considering three configuration changes in this use case example, the buffer will have length 3. The buffer with the total voting scores may be set at 0 for each of the configuration changes, i.e., [0, 0, 0] for [downtilt, no-change, uptilt], and may be updated based on the voting score assigned by each safety shield.

If, for example, the quality is low, the two safety shields may calculate the following voting scores.

Assuming that the RL agent has had good performance thus far and k=0.5 (i.e., the k-shield will equally likely choose either the action selected by the RL agent or the action selected by a baseline policy), k-shield recommends the configuration change selected by the RL agent (uptilt) and thus the voting scores assigned to each configuration change based on Equation 1 may be:

$${vote}_{k - shield}^{uptilt} = 1 \times 1 \times 0 = 0 ;$$

$${vote}_{k - shield}^{downtilt} = 1 \times 0 \times 0 = 0 ;$$

$${vote}_{k - shield}^{notilt} = 1 \times 0 \times 0 = 0 .$$

Wherein the value of confidence score and output has been by default set to 0 for downtilt and notilt, because the k-shield assigns a voting score only to one configuration change, (i.e., the one selected by the RL agent that is uptilt in this case), and does not assign a voting score to the other configuration changes. The voting score for the three configuration changes is therefore [0, 0, 0].

The Bayesian shield may, for example, wrongly estimate that uptilt is a safe action with a confidence score of 0.7 and that downtilt is an unsafe action with a confidence score of 0.3. Thus, according to Equation 1, the voting scores assigned to each configuration change based on Equation 1 may be

$${vote}_{Bayesian}^{uptilt} = 2 \times 0.7 \times 0 = 0 ,$$

$${vote}_{Bayesian}^{downtilt} = 2 \times 0.3 \times 1 = 0.6 ;$$

$${vote}_{Bayesian}^{notilt} = 2 \times 0 \times 0 = 0.$$

Wherein the value of the variables confidence score and output has been by default set to 0 for notilt, because the Bayesian shield assigned a voting score only to uptilt and downtilt. The voting score for the three configuration changes is [0.6, 0, 0].

The total voting score vector is [0.6, 0, 0], wherein the total voting score for each configuration change has been obtained by adding up the voting scores assigned to each configuration change by each safety shield.

Based on the (final) total voting score [0.6, 0, 0], the computing device 201 determines 103 that the configuration change suggested by the RL agent (i.e., uptilt) is unsafe since the total voting score (i.e., 0.6) is not 0 and thus, rejects it. Instead, the computing device 201 may determine to remain at the current tilt angle or downtilt since they are the safest configuration changes (since their total voting score fulfills the voting threshold condition).

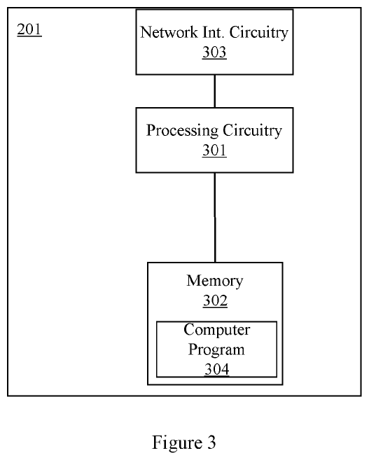

FIG. 3 shows a block diagram illustrating an embodiment of a computing device 201, comprising processor circuitry 301, a computer-readable data carrier, such as the memory 302, and a network interface circuitry 303.

The processing circuitry 301 may comprise one or more processors, such as Central Processing Units (CPUs), microprocessors, application processors, application-specific processors, Graphics Processing Units (GPUs), and Digital Signal Processors (DSPs) including image processors, or a combination thereof, and the memory 302 comprising the computer program 304 comprising instructions. When executed by the processor(s), the instructions cause the computing device 201 to become operative in accordance with embodiments of the invention described herein, in particular with reference to FIG. 1. More specifically, the computing device 201 becomes operative to obtain 101, from two or more safety shields 203a-d, a recommendation to perform or to not perform a configuration change of the environment. The computing device 201 is further operative to determine 103 whether to perform the configuration change based on the recommendation and respective priorities associated with the two or more safety shields. The computing device 201 is further operative to initiate 105 the configuration change if the configuration change is determined to be performed. The two or more safety shields 203a-d may be one or more of Bayesian shield and k-shield. The environment may be a mobile communications network. The configuration change may comprise a change in a network parameter of one or more radio access node of the mobile communications network.

According to an embodiment, the computing device 201 may be further operative to deactivate 107 one of the two or more safety shields 203a-d based on a value of an RL reward function evaluated after performing the configuration change, and/or the priority associated with each of the two or more safety shields.

The computing device 201 may be operative to deactivate one of the two or more safety shields 203a-d based on a value of an RL reward function evaluated after performing the configuration change, and/or the priority associated with each of the two or more safety shields, by deactivating 111 the safety shield 203a-d if the value of the RL reward function evaluated after performing the configuration change recommended by the safety shield 203a-d is lower than a further value of the reward function evaluated after performing a further configuration change recommended by a further safety shield.

Alternatively, the computing device 201 may be operative to deactivate one of the two or more safety shields 203a-d based on a value of an RL reward function evaluated after performing the configuration change, and/or the priority associated with each of the two or more safety shields 203a-d, by deactivating 113 the safety shield 203a-d with the lowest priority, if the value of the RL reward function evaluated after performing the configuration change fulfills a first threshold condition.

According to an embodiment, the computing device 201 may be further operative to re-activate 109 a deactivated safety shield 203a-d based on a performance parameter of the environment.

The computing device 201 may be operative to re-activate 109 a deactivated safety shield 203a-d based on a performance parameter of the environment by, for each performed configuration change, measuring 115 the performance parameter of the environment after performing the configuration change, and by re-activating 117 the deactivated safety shield if the measured performance parameter fulfills a second threshold condition.

The computing device 201 may be operative to determine whether to perform the configuration change further based on a voting score assigned to the configuration change by each safety shield, wherein the voting score is a value based on a confidence score and the priority assigned to the safety shield.

According to an embodiment, the computing device 201 may be further operative to determine 121 a total voting score by adding up or averaging the voting scores assigned for each safety shield to the configuration change. The computing device 201 may be further operative to determine 123 to perform the configuration change if the total voting score fulfills a voting threshold condition.

The computing device 201 may be further operative to assign 125 the priority to the two or more safety shields.

The computing device 201 may communicate with the two or more safety shields (203a-d), through a subscription protocol, such as message queuing telemetry transport, MQTT, protocol, Open Platform Communications Unified Architecture (OPC-UA), Data Distribution Service (DDS), or utilizing any one of a number of transfer protocols, e.g., frame relay, internet protocol (IP), transmission control protocol (TCP), user datagram protocol (UDP), hypertext transfer protocol (HTTP), or by using Remote Procedure Call (RPC) protocols, such as gRPC. For example, the recommendation to perform or to not perform a configuration change of the environment may be sent as a content of a “POST” message. The content of the “POST” message may also comprise a recommended configuration change.

The computer program 304 may be stored in a computer-readable data carrier, such as a memory 302. Alternatively, the computer program 304 may be carried by a data carrier signal, e.g., downloaded to the memory 302 via a network interface circuitry 303. The memory 302 may, e.g., be a Random-Access Memory (RAM), a Read-Only Memory (ROM), a Flash memory, or the like. The computer program 304 may be downloaded to the memory 302 by means of the network interface circuitry 303, as a data carrier signal carrying the computer program 304.

The network interface circuitry 303 may comprise one or more of a cellular modem (e.g., GSM, UMTS, LTE, 5G, or higher generation), a WLAN/Wi-Fi modem, a Bluetooth modem, an Ethernet interface, an optical interface, or the like, for exchanging data between the computing device 201 and other computing devices, communications devices, a radio-access network, and/or the Internet.

The processing circuitry 301 may alternatively or additionally comprise one or more Application-Specific Integrated Circuits (ASICs), Field-Programmable Gate Arrays (FPGAs), or the like, which are operative to cause the computing device 201 to become operative in accordance with embodiments of the invention described herein.

1. A method for selecting configuration changes to be performed in an environment, the method performed by a computing device and comprising:
obtaining, from each of two or more safety shields, a recommendation to perform or to not perform a configuration change of the environment;
determining whether to perform the configuration change based on the recommendations and respective priorities associated with the two or more safety shields; and
initiating the configuration change if the configuration change is determined to be performed.

2. The method of claim 1, wherein
the method further comprises deactivating one of the two or more safety shields based on a value of a reinforcement learning (RL) reward function evaluated after performing the configuration change, and/or the priority associated with each of the two or more safety shields.

3. The method of claim 2, wherein
the method further comprises re-activating a deactivated safety shield based on a performance parameter of the environment.

4. The method of claim 2, wherein
the deactivating one of the two or more safety shields based on a value of an RL reward function evaluated after performing the configuration change, and/or the priority associated with each of the two or more safety shields, further comprises:
deactivating the safety shield if the value of the RL reward function evaluated after performing the configuration change recommended by the safety shield is lower than a further value of the reward function evaluated after performing a further configuration change recommended by a further safety shield.

5. The method of claim 2, wherein
the deactivating one of the two or more safety shields based on a value of an RL reward function evaluated after performing the configuration change, and/or the priority associated with each of the two or more safety shields, further comprises:
deactivating the safety shield with the lowest priority, if the value of the RL reward function evaluated after performing the configuration change fulfills a first threshold condition.

6. The method of claim 3, wherein
the re-activating a deactivated safety shield based on a performance parameter of the environment, further comprises:
for each performed configuration change, measuring the performance parameter of the environment after performing the configuration change; and
re-activating the deactivated safety shield if the measured performance parameter fulfills a second threshold condition.

7. The method of claim 1, wherein
the determining whether to perform the configuration change is further based on a respecting voting score assigned to the configuration change by the two or more safety shields, wherein the voting score is a value based on a confidence score and the priority assigned to the respecting safety shield.

8. The method of claim 7, wherein
the method further comprises:
determining a total voting score by adding up or averaging the voting scores assigned for each safety shield to the configuration change; and
determining to perform the configuration change if the total voting score fulfills a voting threshold condition.

9. The method of claim 1, wherein
the method further comprises assigning the priority to the two or more safety shields.

10-12. (canceled)

13. A computing device for selecting configuration changes to be performed in an environment, the computing device comprising:
a processor; and
a memory, the memory having stored thereon instructions executable by the processor, wherein the instructions, when executed by the processor, cause the computing device to perform a method comprising:
obtaining, from each of two or more safety shields, a recommendation to perform or to not perform a configuration change of the environment;
determining whether to perform the configuration change based on the recommendations and respective priorities associated with the two or more safety shields; and
initiating the configuration change if the configuration change is determined to be performed.

14. The computing device of claim 13, wherein
the method further comprises deactivating one of the two or more safety shields based on a value of a reinforcement learning reward function evaluated after performing the configuration change, and/or the priority associated with each of the two or more safety shields.

15. The computing device of claim 14, wherein
the method further comprises re-activating a deactivated safety shield based on a performance parameter of the environment.

16. The computing device of claim 14, wherein
the deactivating one of the two or more safety shields based on a value of an RL reward function evaluated after performing the configuration change, and/or the priority associated with each of the two or more safety shields, further comprises:
deactivating the safety shield if the value of the RL reward function evaluated after performing the configuration change recommended by the safety shield is lower than a further value of the reward function evaluated after performing a further configuration change recommended by a further safety shield.

17. The computing device of claim 14, wherein
the deactivating one of the two or more safety shields based on a value of an RL reward function evaluated after performing the configuration change, and/or the priority associated with each of the two or more safety shields, further comprises:
deactivating the safety shield with the lowest priority, if the value of the RL reward function evaluated after performing the configuration change fulfills a first threshold condition.

18. The computing device of claim 13, wherein
the re-activating a deactivated safety shield based on a performance parameter of the environment, further comprises:
for each performed configuration change, measuring the performance parameter of the environment after performing the configuration change; and
re-activating the deactivated safety shield if the measured performance parameter fulfills a second threshold condition.

19. The computing device of claim 13, wherein
the determining whether to perform the configuration change is further based on a respecting voting score assigned to the configuration change by the two or more safety shields, wherein the voting score is a value based on a confidence score and the priority assigned to the respecting safety shield.

20. The computing device of claim 19, wherein
the method further comprises:
determining a total voting score by adding up or averaging the voting scores assigned for each safety shield to the configuration change; and
determining to perform the configuration change if the total voting score fulfills a voting threshold condition.

21. The computing device of claim 13, wherein
the method further comprises assigning the priority to the two or more safety shields.

22. The computing device of claim 13, wherein
the two or more safety shields are one or more of Bayesian shield and k-shield.

23-26. (canceled)

27. A non-transitory computer readable storing medium storing a computer program for configuring a computing device comprising processing circuitry operable to execute the computer program to perform the method of claim 1.

28. (canceled)
